(19) United States
(12) Patent Application Publication
(10) Pub. No.: US 2021/0369044 A1
(43) Pub. Date: Dec. 2, 2021

(54) HOT BEVERAGE PREPARER WITH A DRAINAGE DEVICE

(71) Applicant: Miele & Cie. KG, Gûtersloh (DE)

(72) Inventor: Veronika Kukla, Bielefeld (DE)

(73) Assignee: Miele & Cie. KG

(21) Appl. No.: 17/303,038

(22) Filed: May 19, 2021

(30) Foreign Application Priority Data
May 27, 2020 (DE) 10 2020 114 147.5

(51) Int. Cl. A47J 31/44

(52) U.S. Cl. CPC A47J 31/4428

(57) ABSTRACT

A hot beverage preparer includes a flow control system (2) with a water source (14), a brewing unit (40) with a brewing chamber (41) for accommodating of a substance to be brewed (S1) and an inlet line for dispensing brewing water into the brewing chamber (41), a heating device (9) for heating of the water directed into the brewing chamber (41), a pump (8) configured to move the water from the water source (14) to the brewing chamber (41), a control unit (18) for activating or deactivating the selected actuators (8, 9, 72) for preparation of a chosen beverage, and a discharge system (50) having a collection tray (34) for collecting of liquid (AW), with an inlet opening (53) and a filter medium (56) composed of a non-woven material or multi-layered fabric in the collection tray (34).

### TECHNICAL FIELD

A hot beverage preparer with a flow control system includes a water source; a brewing unit with a brewing chamber for accommodating of a substance to be brewed and an inlet line to allow brewing water into the brewing chamber; a heating system for heating the water directed to the brewing chamber; a pump configured to conduct the water from the source to the brewing chamber; a control unit for activating and deactivating the selected actuators for preparation of a chosen beverage; and a drainage device with a collection tray for collecting of liquid and an inlet opening.

### BACKGROUND

A generic hot beverage preparer is known from DE 10 2015 208 212 B3. A filter is disposed immediately above the drainage of the collection tray and is integrated into the collection tray. Thus in this design variant, the coffee grounds are collected together with the remaining liquid in the collection tray, wherein the filter ensures that a separation takes place and the waste water is drained away via an outlet present in the collection tray.

### SUMMARY

Thus the object of the invention is to present a hot beverage preparer with a simple and improved collection tray.

According to the invention, this objective is met inter alia by a hot beverage preparer having a drainage device with a collection tray for collecting liquid (AW), wherein the collection tray (34) includes an inlet opening and a filter medium composed of a non-woven material or multi-layered fabric within the collection tray.

One advantage attainable with the invention is that the wastewater and remaining liquid are reliably cleaned from sediment. It is thereby ensured that the outlet opening and the outlet hose, if present, do not become clogged. Furthermore, it is advantageous to place a valve in the outlet opening. With the improved filtration of the wastewater, the valve is not restricted in regards to its closing function. Furthermore, the advantage achieved is that the collected wastewater does not develop mold as fast as wastewater contaminated with sediment.

To this end, the drainage device comprises a filter medium composed of a non-woven material or a multi-layered fabric arranged in the tray. Due to the chaotic fiber structure, a dependable retention of sediment and grains, as well as an extremely good permeability of water, is achieved. The result is that the filter medium dries faster than a typical sieve, in which the sediment builds up as filter residue. An additional advantage is that the filter medium made of the aforementioned non-woven material or multi-layered fabric is bendable or flexible, so that it can be easily removed from the tray and rinsed.

In a practical design, the collection tray is equipped with an outlet opening in its lower area or on its base, for the purpose of discharging the collected fluid.

In a preferred embodiment, the filter medium is configured such that it exhibits a thickness which approximately corresponds to the depth of the tray. Thus the internal space of the tray is nearly or completely filled. Due to the extension in depth, the active filter layer is enlarged to an extreme degree, without enlarging the present collection tray.

In an overall practical design, the tray comprises a base with a slope toward the outlet opening, in order to improve the drainage of the filtered wastewater. For this and all other design embodiments, the tray base can be provided with a hydrophobic structure, in order to achieve a so-called lotus effect.

In an additional, overall favorable design, the drainage device comprises a plurality of spacer arrangement for placement of the filter medium in the tray, in order to create a separation between the underside of the filter medium and the base of the tray. Thus drainage is effected underneath the mat-shaped filter medium, so that the filter medium can quickly dry. Overall, microbial growth in the filter medium is prevented, or rather at least slowed.

To this end, protrusions affixed to or formed in or on the base of the collection tray have proven to be practical, preferably rounded, convex, or truncated conical forms or shapes. The underside of the filter medium rests on these protrusions, so that this function is provided by the spacer arrangement. The protrusions or single-piece forms have the advantage that they hardly impede the fluid stream underneath the filtering mat. Furthermore, they do not impede manual rinsing of the collection tray.

In another development of the spacer arrangement, a grate or grate frame placed in the collection tray is used, which is either firmly affixed or removable.

The filter medium can be laid atop the grate, wherein the grate is dimensioned such that the flexible filter medium does not touch the base.

In an overall practical design, the filter medium is dimensioned such that it completely or almost completely fills the surface of the inlet opening of the collection tray.

It is preferable that the tray is configured as open on the top, so that the filter medium covers the entire surface of the tray. This dimensioning can be used in this manner for all design embodiments. Thus any falling drops of liquid from various areas inside the device can reliably be filtered in the collection tray. Furthermore, dust, which can be generated for example when grinding coffee beans, can be reliably captured in the filter medium and retained there. Conduction of the dust to the outlet opening does not take place due to the filtering action.

The filter medium preferably has a pore size for capturing of sediment with a particle size larger than 30 micrometers (μm) in diameter. In a preferred embodiment, a woven or non-woven geotextile is used as a filter medium, which is very affordable to manufacture and fulfills the desired filter properties.

An exemplary embodiment of the invention is presented purely schematically in the illustrations and is subsequently described in greater detail.

### BRIEF DESCRIPTION OF THE DRAWINGS

In the drawings,

FIG. 1 shows a hot beverage preparer in a partially schematic sectional depiction; and

FIGS. 2, 3, 4 and 5 show the drainage device in various schematic views and configurations.

### DETAILED DESCRIPTION OF THE DRAWINGS

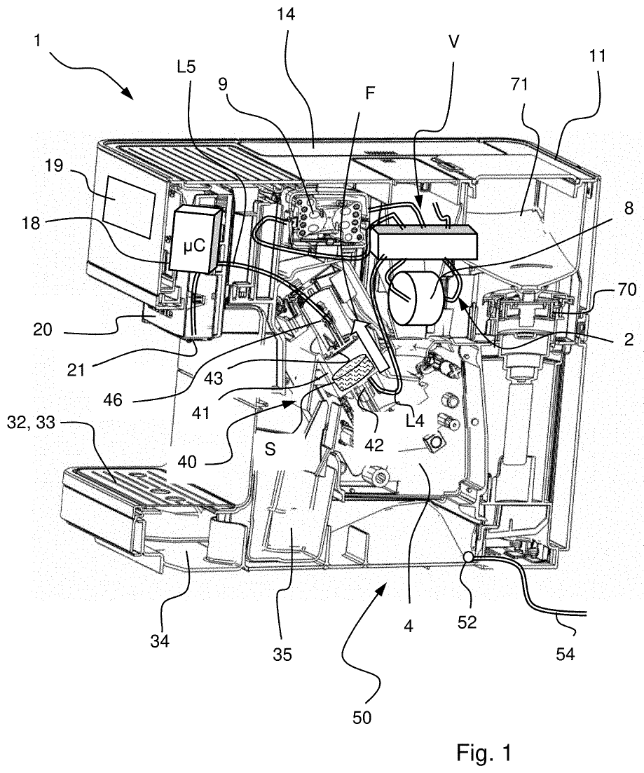

FIG. 1 shows as an example a hot beverage preparer 1 configured as a floor-mounted appliance with all relevant components for the preparation of a hot beverage. The beverage preparer 1 comprises inter alia a housing 11, in which the reservoir 71 for coffee beans [is disposed, with a grinder 70 with motor mounted beneath, the water reservoir 14, as well as the possibility of housing the flow control system 2. In the frontal area of the hot beverage preparer 1, the unit has a highly movable outlet 20, in which a plurality of discharge devices, here outlet nozzles 21, are located. The discharge device 21 represents an output line or output nozzle 21, for the dispensing of coffee beverages. A brewing unit 40 with a brewing chamber 41 inside the device 1 serves for the preparation of the beverage, wherein the coffee powder is introduced into the brewing chamber 41 and is subsequently flooded with hot water, so that the finished coffee beverage is dispensed to the output line and through the output nozzle 21. In this embodiment, the output nozzles 21 are disposed movably with regard to their height, so that they can be adjusted to the height of a drinking vessel placed on the platform 33, without the dispensing of the beverage resulting in overspray. The upper termination of the platform 33 forms a drip tray 32 provided with openings and slits, in order to conduct residual liquid into a collection tray 34 below the drip tray 32. Furthermore, the hot beverage preparer 1 comprises a pomace holder 35, into which the depleted substance, for example coffee grounds, can be discarded after completion of the beverage preparation. The device 1 furthermore comprises a control unit 18 configured to control the individual function modules, such as pumps 8, valves V, and heating device 9 and grinder 70, to the extent that they are present, as is necessary for the preparation of the respectively chosen beverage. The control unit 18 configured as a microcontroller act with an associated memory unit, is in this embodiment further configured to control the valves V of the flow control system 2 such that the hot water is pumped through the brewing chamber 41.

For all design examples explained here, the brewing chamber 41 is configured as cylindrical, wherein the substance to be brewed S is introduced here for brewing. After filling, the upper front face is closed with the brewing sieve 43, wherein the substance S is compressed with the brewing sieve 43 within the brewing chamber 41. The hot water is admitted into the inlet 42 on the bottom side of the front face, wherein the brewing liquid travels through the brewing sieve 43 and preferably through a subsequent pressure valve 46 to the output nozzle 21.

The interface and display device 19 is disposed on the outside of the front wall of the housing 11, in this example it is configured with touch pads and a display or as a touchscreen, to allow for selections relating to the choice of beverage and additional settings with respect to water quantity, taste strength, or type of beans. The interface and display device 19 thereby has a data connection with the control unit 18 or rather with the microprocessor μC present therein.

The control unit 18 with a microcontroller μC and a memory device MEM serves for preparation of a beverage, wherein the activation of the heating device 9, the valves of the valve device V, as well as the pumps 8, the brewing chamber 40, and additional components if applicable, such as a grinder 70, is handled via corresponding signal connections (not depicted).

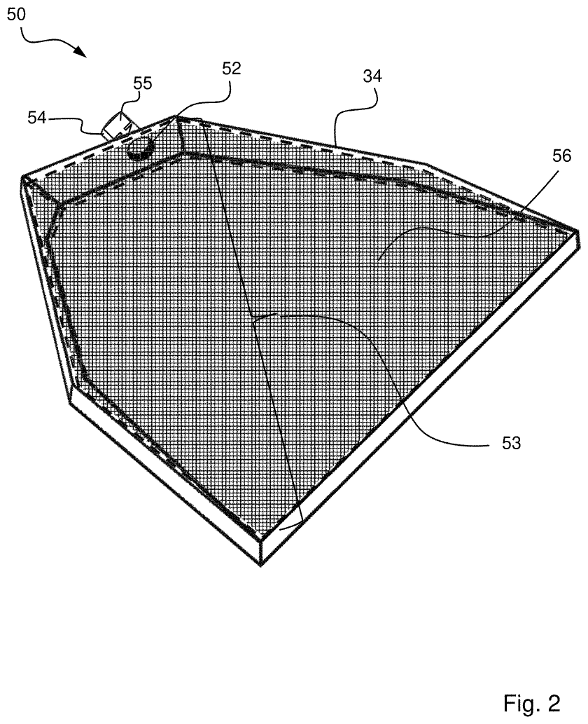

FIG. 2 shows the drainage device 50 in a schematic detailed view. The collection tray 34 as the central function module comprises a tray base 51 configured with a slope toward the outlet opening 52. The slope performs the function of a funnel, in order to direct the wastewater entering into the tray 34 toward the outlet opening 52. The tray 34 is configured with an open top that forms the inlet opening 53 for the incoming wastewater AW. In the depiction, the diagonal diameter of the inlet opening 53 is marked to illustrate the maximum-sized cross-section. The filter medium 56 is placed in the tray 34. In the presented example, the filter medium 56 fills the inside of the tray 34 completely, or at least almost completely. The outlet hose 54 is downstream of the outlet opening 52, and is provided for connection to a drain channel. A check valve can be disposed in the outlet opening or immediately behind it, in order to prevent the outflow of remaining wastewater when the collection tray 34 is pulled out of the device housing 11. The named components and their placement are for the most part visible in FIG. 1 as well.

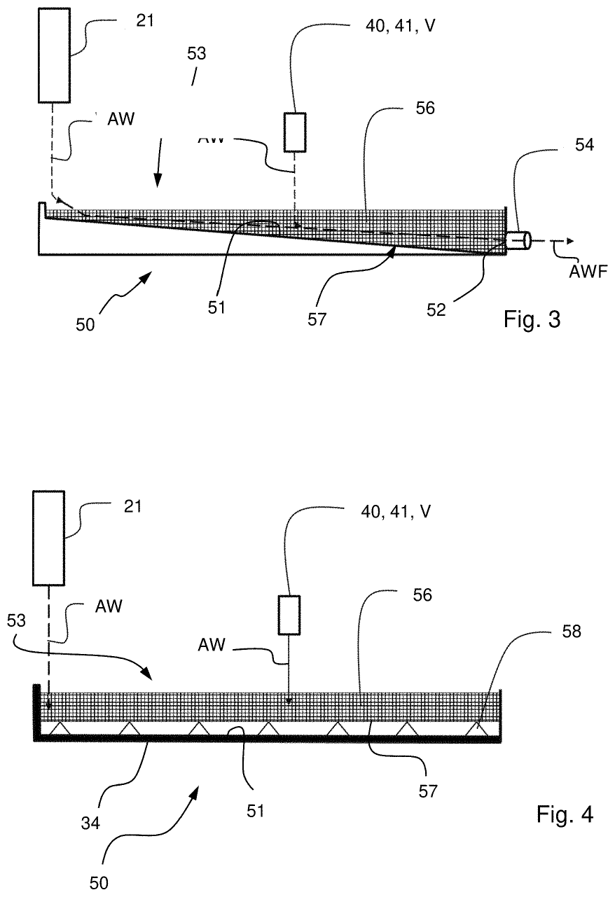

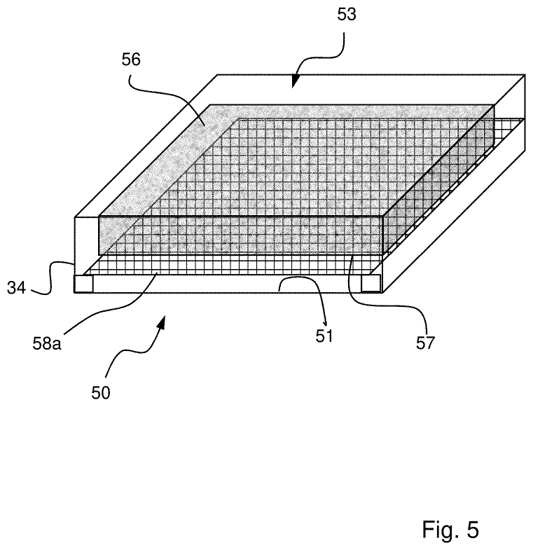

FIG. 3 shows the drainage device 50 in a schematic side view. The collection tray 34 has a base 51 with a slope toward the outlet opening 52. The outlet opening 52 is thereby preferably located at the lowest point in the collection tray 34, which is not very clearly represented in the schematic drawing. The line 54 is connected to the outlet opening 52 which conducts the filtered wastewater AWF to the outside and can be connected to a drain channel. The inlet opening 53 is filled with the filter medium 56. The output 20 or rather the output nozzle 21 for the beverage and the brewing unit 40 are possible sources for wastewater AW. Additional sources, such as outlet lines or valves V for the outlet of rinse water or cleaning solution are also possible. The wastewater AW from these sources makes its way onto or into the filter medium 56, which the inlet opening 53 covers completely. In the illustrated example, the filter medium 56 is shaped as a block and completely fills the inner space of the tray 34. The underside 57 of the filter block 56 therefore follows the contour of the tray base 51.

FIG. 4 shows the drainage device 50 in a schematic side view. In the example shown, the collection tray has no outlet opening and serves for the collection of wastewater AW. The wastewater AW is thereby free of sediment, wherein the sediment remains in the filter medium as grains and dries there, as it is no longer in the water. The collection tray 34 can have a base 51 with a slope toward the outlet opening 52 (FIG. 3), if an outlet opening is present. The outlet opening 52 is thereby preferably located at the lowest point in the collection tray 34, which is not very clearly represented in the schematic drawing. The line 54 (shown in FIGS. 2 and 3) is attached to the outlet opening 52, which guides the filtered wastewater AWF to the outside and can be connected to a drain channel. The inlet opening 53 is filled with the filter medium 56. Possible sources of wastewater AW are the output 20 or rather the output nozzle 21 for the beverage and the brewing unit 41. Additional sources, such as outlet lines for the outlet of rinse water or cleaning solution are also possible. The wastewater AW from these sources makes its way onto or into the filter medium 56, which covers the inlet opening 53 completely. In the example shown, the filter medium 56 is shaped as a block and fills the inside of the tray 34 in such a way that there is a space between it and the tray base 51.

The underside 57 of the filter block 56 herein rests on a spacer arrangement 58 affixed to the tray base 51. The spacer arrangement 58 is preferably configured as bulges or recesses from the tray base 51. Conical shapes are illustrated here; convex or rounded-off shapes are advantageous, as they are easier to clean.

FIG. 4 shows the drainage device 50 in a schematic side view. In the example shown, the collection tray has no outlet opening and serves for the collection of wastewater AW. The wastewater AW is thereby free of sediment, wherein the sediment remains in the filter medium as grains and dries there, as it is no longer in the water. The collection tray 34 can have a base 51 with a slope toward the outlet opening 52 (FIG. 3), if an outlet opening is present. The outlet opening 52 is thereby preferably located at the lowest point in the collection tray 34, which is not very clearly represented in the schematic drawing. The inlet opening 53 is filled with the filter medium 56. The wastewater AW makes its way onto or into the filter medium 56, which covers the inlet opening 53 completely. In the example shown, the filter medium 56 is shaped as a block and fills the inside of the tray 34 in such a way that there is a space between it and the tray base 51.

The underside 57 of the filter block 56 of this example rests on a spacer arrangement 58a formed by a grate resting on steps formed on the collection tray 34. The grate 58a may alternatively be affixed to the collection tray 34.

1. A hot beverage preparer (1) comprising
a flow control system (2) with a water source (14),
a brewing unit (40) including a brewing chamber (41) for accommodating a substance to be brewed (S1) and an inlet line to direct water into the brewing chamber (41),
a heating device (9) for heating the water directed into the brewing chamber (41)
a pump (8) which is configured to move the water from the water source (14) to the brewing chamber (41),
a control unit (18) for activating or deactivating selected actuators (8, 9, 72) for preparing a chosen beverage, and
a drainage device (50), the drainage device having:
a collection tray (34) for collecting liquid (AW), the collection tray (34) including an inlet opening (53), and
a filter medium (56) composed of a non-woven material or multi-layered fabric within the collection tray (34).

2. The hot beverage preparer according to claim 1, further comprising an outlet opening (52) disposed in the collection tray (34) for discharging the collected liquid (AW).

3. The hot beverage preparer according to claim 2, wherein the collection tray (34) comprises a tray base (51) with a slope toward the outlet opening (52).

4. The hot beverage preparer according to claim 1, wherein the collection tray (34) has a depth and the filter medium (56) has a thickness corresponding to the depth of the collection tray (34).

5. The hot beverage preparer according to claim 1, wherein the collection tray (34) has a tray base (51), the drainage device further comprising a spacer arrangement (58) for placing the filter medium (56) in the collection tray (34), the spacer arrangement (58) defining a space between the filter medium (56) and the tray base (51).

6. The hot beverage preparer according to claim 5, wherein the tray base (51) has protrusions (58) forming the spacer arrangement (58).

7. The hot beverage preparer according to claim 5, wherein the spacer arrangement (58) is a grate placed in or affixed to the collection tray (34).

8. The hot beverage preparer according to claim 1, wherein the filter medium (56) covers the inlet opening (53) of the collection tray (34).

9. The hot beverage preparer according to claim 1, wherein the filter medium (56) has a pore size for retaining sediments with a grain size of a diameter greater than 30 micrometers.

10. The hot beverage preparer according to claim 1, wherein the filter medium (56) comprises a geotextile or consists of a geotextile.
